(19) United States
(12) Patent Application Publication
(10) Pub. No.: US 2012/0118197 A1
(43) Pub. Date: May 17, 2012

(54) BUILDING MATERIALS RESISTANT TO ROOT PENETRATION AND METHODS FOR MAKING THE SAME

(75) Inventors: Alexander Cornish, Basel (CH); Hanno Christian Wolf, Stein (CH)

(73) Assignee: LANXESS DEUTSCHLAND GMBH, Leverkusen (DE)

(21) Appl. No.: 13/131,105

(22) PCT Filed: Nov. 26, 2009
(86) PCT No.: PCT/GB09/02761

§ 371 Date: Jan. 20, 2012

(30) Foreign Application Priority Data
Dec. 2, 2008 (GB) 0822004.8

(51) Int. Cl. C09D 5/14

(52) U.S. Cl. 106/18.32

(57) ABSTRACT

The present invention relates to building materials which are resistant to root penetration and methods for making such materials. In particular, the building materials comprise a root penetration inhibiting amount of Napropamide and the materials comprise bitumen.

The present invention relates to building materials which are resistant to root penetration and methods for making such materials. In particular, the building materials comprise a root penetration inhibiting amount of Napropamide.

Plant roots can penetrate building materials ultimately causing significant damage to both the material and its surround. For example, when plant roots cause the deterioration of waste water pipes, the leaking water can contaminate the area resulting in environmental damage. Further examples can be found when plant roots penetrate the bitumen present in roads and roofing materials thereby compromising the structural integrity of such materials.

These problems have been previously addressed via the provision of compounds having herbicidal properties to prevent damage caused by plant roots. There exists, however, a need for the provision of improved compounds which demonstrate enhanced efficacy, are environmentally acceptable and possess other qualities such as improved leaching resistance. The present invention seeks to provide such a compound for use in this technical area and which does not contain any of the drawbacks of the compounds in the prior art.

According to the present invention there is provided a building material comprising an amount of Napropamide sufficient to inhibit penetration of said material by a plant root.

In a further aspect of the invention there is provided a material comprising an amount of Napropamide which is effective to prevent or significantly reduce the contact between a plant root and the material when said root is growing in close proximity to said material. In this instance, the Napropamide containing material can be used to effectively contain the roots in close proximity to the material without substantially contacting the material. An example of such a material is a plant container such as a plant pot. Such material containing Napropamide could be used to ensure the roots are contained in a particular way by minimising contact with the material which avoids any damage to the roots when the plant and roots are removed from the material. In a particular embodiment said material is a plastics material. In a further embodiment said material is a plant container.

Napropamide, (N,N-diethyl-2-(1-naphthyloxy)propanamide), is listed as entry 572 in The Pesticide Manual—Thirteenth Edition, published by The British Crop Protection Council, 2003. It is a selective systemic herbicide and is used in the agricultural sector. Surprisingly, this compound maintains good efficacy when added to building materials and enables the prevention of root penetration and damage without significantly affecting the root and thus killing the plant. This enables the use of building materials in agricultural environments wherein the materials can be protected from damage by the plant roots without damaging the roots themselves. This effect is, in part, achieved via the surprising relative leaching resistance of Napropamide when added to the building material in accordance with the invention. Furthermore, surprisingly, Napropamide can be used in relatively lower quantities and still achieve the effect of root penetration inhibition.

The building material comprising Napropamide can be generated via a number of techniques which are well known to the person skilled in the art. The particular method employed may depend upon the type of material to be treated. Treatment examples include absorbing, impregnating, treating (in closed pressure or vacuum systems) said material with Napropamide, dipping or soaking the building material, or coating the building material for example by curtain coating, roller, brush, spray, atomisation, dusting, scattering or pouring application.

In a particular embodiment of the invention said building material is selected from the group consisting of: bitumen, roofing materials, sealants, insulation, plastics, geotextiles, tunnel liner and piping. In a specific embodiment of the invention said building material is bitumen. In a further embodiment said material is roofing materials. In a still further embodiment said material is sealants. In a still further embodiment said material is insulation. In a still further embodiment said material is tunnel liner. In a still further embodiment said material is plastics. Plastics includes plastic polymers and copolymers, including: acrylonitrile butadiene styrene, butyl rubber, epoxies, fluoropolymers, isoprene, nylons, polyethylene, polyurethane, polypropylene, polyvinyl chloride, polystyrene, polycarbonate, polyvinylidene fluoride, polyacrylate, polymethyl methacrylate, polyurethane, polybutylene, polybutylene terephthalate, polyether sulfone, polyphenyllenoxide, polyphenylene ether, polyphenylene sulfide, polyphtatamide, polysulphene, polyester, silicone, styrene butadiene rubber and combinations of polymers. In a further embodiment building material means polyvinyl chloride (PVC). In a further embodiment building material means polyurethane (PU). In a further embodiment building materials means paint. In a further embodiment building material means wood plastic composite (WPC). Wood plastic composite is a material that is well known in the art. A review of WPCs can be found in the following publication—Craig Clemons—Forrest Products Journal. June 2002 Vol 52. No. 6. pp 10-18.

In a still further embodiment said material is geotextiles. Geotextiles are permeable fabrics that can be used in soil to drain, filter, reinforce, protect, or separate. They can be made from materials including polyester and polypropylene.

In a still further embodiment said material is piping. Other building materials which are encompassed by the present invention include adhesives, joining materials and rubber.

In a particular embodiment of the invention the building materials comprising Napropamide demonstrate improved leaching resistance when compared to compounds used in this context in the prior art.

The present invention still further provides a material as described above which comprises an additional compound selected from the group consisting of: herbicides, insecticides and fungicides.

Examples of herbicidal compounds which can be used in accordance with the present invention include: acetochlor, acifluorfen, acifluorfen-sodium, aclonifen, acrolein, alachlor, alloxydim, allyl alcohol, ametryn, amicarbazone, amidosulfuron, aminopyralid, amitrole, ammonium sulfamate, anilofos, asulam, atrazine, aviglycine, azafenidin, azimsulfuron, BCPC, beflubutamid, benazolin, bencarbazone, benfluralin, benfuresate, bensulfuron, bensulfuron-methyl, bensulide, bentazone, benzfendizone, benzobicyclon, benzofenap, bifenox, bilanafos, bispyribac, bispyribac-sodium, borax, bromacil, bromobutide, bromophenoxim, bromoxynil, butachlor, butafenacil, butamifos, butralin, butroxydim, butylate, cacodylic acid, calcium chlorate, cafenstrole, carbetamide, carfentrazone, carfentrazone-ethyl, CDEA, CEPC, chlorflurenol, chlorflurenol-methyl, chloridazon, chlorimuron, chlorimuron-ethyl, chloroacetic acid, chlorotoluron, chlorpropham, chlorsulfuron, chlorthal, chlorthal-dimethyl, cinidon-ethyl, cinmethylin, cinosulfuron, cisanilide, clethodim, clodinafop, clodinafop-propargyl, clomazone, clomeprop, clopyralid, cloransulam, cloransulam-methyl, CMA, 4-CPB, CPMF, 4-CPP, CPPC, cresol, cumyluron, cyanamide, cyanazine, cybutryn, cycloate, cyclosulfamuron, cycloxydim, cyhalofop, cyhalofop-butyl, 2,4-D, 3,4-DA, daimuron, dalapon, dazomet, 2,4-DB, 3,4-DB, 2,4-DEB, desmedipham, desmetryn, dicamba, dichlobenil, orthodichlorobenzene, para-dichlorobenzene, dichlorprop, dichlorprop-P, diclofop, diclofopmethyl, diclosulam, difenzoquat, difenzoquat metilsulfate, diflufenican, diflufenzopyr, dimefuron, dimepiperate, dimethachlor, dimethametryn, dimethenamid, dimethenamidP, dimethipin, dimethylarsinic acid, dinitramine, dinoterb, diphenamid, dipropetryn, diquat, diquat dibromide, dithiopyr, diuron, DNOC, 3,4-DP, DSMA, EBEP, endothal, EPTC, esprocarb, ethalfluralin, ethametsulfuron, ethametsulfuron-methyl, ethephon, ethofumesate, ethoxyfen, ethoxysulfuron, etobenzanid, fenoxaprop, fenoxaprop-P, fenoxaprop-ethyl, fenoxaprop-P-ethyl, fentrazamide, ferrous sulfate, flamprop-M, flazasulfuron, florasulam, fluazifop, fluazifop-butyl, fluazifop-P, fluazifop-P-butyl, fluazolate, flucarbazone, flucarbazone-sodium, flucetosulfuron, fluchloralin, flufenacet, flufenpyr, flufenpyr-ethyl, flumetralin, flumetsulam, flumiclorac, flumiclorac-pentyl, flumioxazin, flumipropin, fluometuron, fluoroglycofen, fluoroglycofen-ethyl, fluoxaprop, flupoxam, flupropacil, flupropanate, flupyrsulfuron, flupyrsulfuron-methyl-sodium, flurenol, fluridone, fluorochloridone, fluoroxypyr, flurtamone, fluthiacet, fluthiacet-methyl, fomesafen, foramsulfuron, fosamine, glufosinate, glufosinate-ammonium, glyphosate, halosulfuron, halosulfuron-methyl, haloxyfop, haloxyfop-P, HC-252, hexazinone, imazamethabenz, imazamethabenz-methyl, imazamox, imazapic, imazapyr, imazaquin, imazethapyr, imazosulfuron, indanofan, iodomethane, iodosulfuron, iodosulfuron-methyl-sodium, ioxynil, isoproturon, isouron, isoxaben, isoxachlortole, isoxaflutole, isoxapyrifop, karbutilate, lactofen, lenacil, linuron, MAA, MAMA, MCPA, MCPA-thioethyl, MCPB, MCPP (2-methyl 4-chlorophenoxypropionic acid), mecoprop, mecoprop-P, mefenacet, mefluidide, mesosulfuron, mesosulfuron-methyl, mesotrione, metam, metamifop, metamitron, metazachlor, methabenzthiazuron, methazole, methylarsonic acid, methyldymron, methyl isothiocyanate, metobenzuron, metobromuron, metolachlor, S-metolachlor, metosulam, metoxuron, metribuzin, metsulfuron, metsulfuron-methyl, MK-616, molinate, monolinuron, MSMA, naproanilide, napropamide, naptalam, NDA-402989, neburon, nicosulfuron, nipyraclofen, n-methyl glyphosate, nonanoic acid, norflurazon, oleic acid (fatty acids), orbencarb, orthosulfamuron, oryzalin, oxadiargyl, oxadiazon, oxasulfuron, oxaziclomefone, oxyfluorfen, paraquat, paraquat dichloride, pebulate, pendimethalin, penoxsulam, pentachlorophenol, pentanochior, pentoxazone, pethoxamid, petrolium oils, phenmedipham, phenmedipham-ethyl, picloram, picolinafen, pinoxaden, piperophos, potassium arsenite, potassium azide, pretilachlor, primisulfuron, primisulfuron-methyl, probutryn, prodiamine, profluazol, profoxydim, prohexadione-calcium, prometon, prometryn, propachior, propanil, propaquizafop, propazine, propham, propisochior, propoxycarbazone, propoxycarbazone-sodium, propyzamide, prosulfocarb, prosulfuron, pyraclonil, pyraflufen, pyraflufen-ethyl, pyrasulfotole, pyrazolynate, pyrazosulfuron, pyrazosulfuron-ethyl, pyrazoxyfen, pyribenzoxim, pyributicarb, pyridafol, pyridate, pyriftalid, pyriminobac, pyriminobac-methyl, pyrimisulfan, pyrithiobac, pyrithiobacsodium, pyroxasulfone, pyroxulam, quinclorac, quinmerac, quinoclamine, quizalofop, quizalofop-P, quizalofop-ethyl, quizalofop-P-ethyl, rimsulfuron, sethoxydim, siduron, simazine, simetryn, SMA, sodium arsenite, sodium azide, sodium chlorate, sulcotrione, sulfentrazone, sulfometuron, sulfometuron-methyl, sulfosate, sulfosulfuron, sulfuric acid, tar oils, 2,3,6-TBA, TCA, TCA-sodium, tebutam, tebuthiuron, tefuryltrione, tembotrione, tepraloxydim, terbacil, terbumeton, terbuthylazine, terbutryn, thenylchior, thiazafluoron, thiazopyr, thifensulfuron, thiencarbazone, thifensulfuron-methyl, thiobencarb, tiocarbazil, topramezone, tralkoxydim, tri-allate, triasulfuron, triaziflam, tribenuron, tribenuronmethyl, tricamba, triclopyr, trietazine, trifloxysulfuron, trifloxysulfuron-sodium, trifluralin, triflusulfuron, triflusulfuron-methyl, trifop, trifop-methyl, trihydroxytriazine, trinexapacethyl, tritosulfuron, [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetic acid ethyl ester (CAS RN 353292-31-6), 4-hydroxy-3-[[2-[(2-methoxyethoxy)methyl]-6-(trifluoromethyl)-3-pyridinyl]carbonyl]-bicyclo[3.2.1]oct-3-en-2-one (CAS RN 352010-68-5), and 4-hydroxy-3-[[2-(3-methoxypropyl)-6-(difluoromethyl)-3-pyridinyl]carbonyl]-bicyclo[3.2.1]oct-3-en-2-one.

Examples of insecticidal compounds which can be used in accordance with the present invention include: Pyrethroids, such as permethrin, cypermethrin, fenvalerate, esfenvalerate, deltamethrin, cyhalothrin (in particular lambda-cyhalothrin), bifenthrin, fenpropathrin, cyfluthrin, tefluthrin, fish safe pyrethroids (for example ethofenprox), natural pyrethrin, tetramethrin, s-bioallethrin, fenfluthrin, prallethrin or 5-benzyl-3-furylmethyl-(E)-(1R,3S)-2,2-dimethyl-3-(2-oxothiolan-3-ylidenemethyl)cyclopropane carboxylate;

Organophosphates, such as, profenofos, sulprofos, acephate, methyl parathion, azinphos-methyl, demeton-s-methyl, heptenophos, thiometon, fenamiphos, monocrotophos, profenofos, triazophos, methamidophos, dimethoate, phosphamidon, malathion, chlorpyrifos, phosalone, terbufos, fensulfothion, fonofos, phorate, phoxim, pirimiphos-methyl, pirimiphos-ethyl, fenitrothion, fosthiazate or diazinon;
Carbamates (including aryl carbamates), such as pirimicarb, triazamate, cloethocarb, carbofuran, furathiocarb, ethiofencarb, aldicarb, thiofurox, carbosulfan, bendiocarb, fenobucarb, propoxur, methomyl or oxamyl; Benzoyl ureas, such as diflubenzuron, triflumuron, hexaflumuron, flufenoxuron or chlorfluazuron; Organic tin compounds, such as cyhexatin, fenbutatin oxide or azocyclotin; Pyrazoles, such as tebufenpyrad and fenpyroximate; Macrolides, such as avermectins or milbemycins, for example abamectin, emamectin benzoate, ivermectin, milbemycin, spinosad or azadirachtin; Hormones or pheromones; Organochlorine compounds such as endosulfan, benzene hexachloride, DDT, chlordane or dieldrin; Amidines, such as chlordimeform or amitraz; Fumigant agents, such as chloropicrin, dichloropropane, methyl bromide or metam; Neonicotinoid compounds such as imidacloprid, thiacloprid, acetamiprid, nitenpyram, dinotefuran, thiamethoxam or sulfoxaflor; Diacylhydrazines, such as tebufenozide, chromafenozide or methoxyfenozide; Diphenyl ethers, such as diofenolan or pyriproxifen; lndoxacarb; Chlorfenapyr; Pymetrozine; Tetronic acids such as spirotetramat, spirodiclofen or spiromesifen; Spinosyns, such as spinosad, or spinetoram; or Anthranilic diamides such as flubendiamide, Cyazypyr™ or Rynaxypyr™.

Examples of fungicidal compounds that may be used in accordance with the invention include: AC 382042 (N-(1-cyano-1,2-dimethylpropyl)-2-(2,4-dichlorophenoxy)propionamide), acibenzolar-5-methyl, alanycarb, aldimorph, anilazine, azaconazole, azafenidin, azoxystrobin, benalaxyl, benomyl, benthiavalicarb, biloxazol, bitertanol, blasticidin S, boscalid (new name for nicobifen), bromuconazole, Bronopol, bupirimate, captafol, captan, carbendazim, carbendazim chlorhydrate, carboxin, carpropamid, carvone, CGA 41396, CGA 41397, chinomethionate, chlorbenzthiazone, chlorothalonil, chlorozolinate, clozylacon, copper containing compounds such as copper oxychloride, copper oxyquinolate, copper sulphate, copper tallate, and Bordeaux mixture, cyamidazosulfamid, cyazofamid (IKF-916), cyflufenamid, cymoxanil, cyproconazole, cyprodinil, debacarb, di-2-pyridyl disulphide 1,1′-dioxide, dichlofluanid, diclocymet, diclomezine, 4,5-Dichloro-2-n-Octyl-3-Isothiazolinone (DCOIT), dicloran, diethofencarb, difenoconazole, difenzoquat, diflumetorim, diiodomethyl-p-tolylsulfone (Amical, from Dow) O,O-di-iso-propyl-5-benzyl thiophosphate, dimefluazole, dimetconazole, dimethirimol, dimethomorph, diniconazole, dinocap, dithianon, Dithiocarbamates, dodecyl dimethyl ammonium chloride, dodemorph, dodine, doguadine, edifenphos, epoxiconazole, ethaboxam, ethirimol, ethyl(Z)—N-benzyl-N([methyl(methylthioethylideneaminooxycarbonyl)amino]thio)-β-alaninate, etridiazole, famoxadone, fenamidone, fenarimol, fenbuconazole, fenfuram, fenhexamid, fenoxanil (AC 382042), fenpropidin, fenpropimorph, fentin acetate, fentin hydroxide, ferbam, ferimzone, fluazinam, fludioxonil, flumetover, flumorph, fluoroimide, fluquinconazole, flusilazole, flusulfamide, flutolanil, flutriafol, folpet, fosetyl-aluminium, fuberidazole, furalaxyl, furametpyr, guazatine, hexaconazole, hydroxyisoxazole, hymexazole, imazalil, imibenconazole, iminoctadine, iminoctadine triacetate, 3-iodo-2-propynyl butylcarbamate (IBPC), ipconazole, iprobenfos, iprodione, iprovalicarb, isopropanyl butyl carbamate, isoprothiolane, isopyrazam, kasugamycin, LY186054, LY211795, LY 248908, mancozeb, maneb, MBT mefenoxam, mepanipyrim, mepronil, metalaxyl, metalaxyl M, metconazole, metiram, metiram-zinc, metrafenone, MON65500 (N-allyl-4,5-dimethyl-2-trimethylsilylthiophene-3-carboxamide), myclobutanil, NTNO301, neoasozin, nickel dimethyldithiocarbamate, nitrothale-isopropyl, nuarimol, 2-O-octyl-4-isothiazolin-3-one (Skane M 8 Rohm& Hass), ofurace, organomercury compounds, oxadixyl, oxasulfuron, oxolinic acid, oxpoconazole, oxycarboxin, pefurazoate, penconazole, pencycuron, phenazin oxide, phosphorus acids, phthalide, polyoxin D, polyram, probenazole, prochloraz, procymidone, propamocarb, propamocarb hydrochloride, propiconazole, propineb, propionic acid, proquinazid, prothioconazole, pyrazophos, Sodium and Zinc Pyrithione (Omadine chemistry from Arch Chem.), pyrifenox, pyrimethanil, pyroquilon, pyroxyfur, pyrroInitrin, quaternary ammonium compounds, quinomethionate, quinoxyfen, quintozene, sedaxane, silthiofam (MON 65500), S-imazalil, simeconazole, sipconazole, sodium pentachlorophenate, spiroxamine, streptomycin, sulphur, tebuconazole, tecloftalam, tecnazene, tetraconazole, thiabendazole, thifluzamide, 2-(thiocyanomethylthio)benzothiazole, thiophanate-methyl, thiram, tiadinil, timibenconazole, toiclofos-methyl, tolylfluanid, triadimefon, triadimenol, triazbutil, triazoxide, tricyclazole, tridemorph, triflumizole, triforine, triticonazole, validamycin A, vapam, vinclozolin, XRD-563, zineb, ziram, zoxamide and compounds of the formulae:

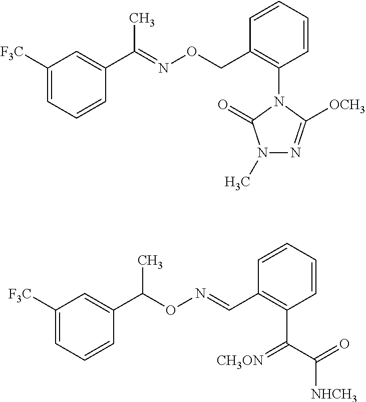

The building materials according to the invention may also contain additional means to further enhance the materials resistance to root penetration. Such means may include for example, additional root inhibiting compounds.

The present invention still further provides a building comprising a material as described above. In a particular embodiment said building is a temporary building. In a further embodiment said building is a permanent structure.

The present invention still further provides a method for protecting a building material from damage resulting from penetration of said material by a plant root the method comprising adding and/or treating said material with an amount of Napropamide which is sufficient to prevent penetration of said material by a plant root. The Napropamide may be added in accordance with methods well known the person skilled in the art and for example via the methods as described above.

In a particular embodiment of said method, the Napropamide is added during manufacture of said material. In a further embodiment of said method, said material is treated with Napropamide after manufacture of said material.

In a particular embodiment of said method the material is bitumen. In a further embodiment of said method said material is roofing materials. In a still further embodiment of said method said material is sealants. In a still further embodiment of said method said material is insulation. In a still further embodiment of said method said material is plastics. In a still further embodiment of said method said material is geotextiles. In a still further embodiment of said method said material is tunnel liner. In a still further embodiment of said method said material is piping. In a still further embodiment of said method said material is one as described above. In a still further embodiment said method involves a mixture containing Napropamide as described above.

The present invention still further provides the use of Napropamide in the manufacture of a building material resistant to penetration of a plant root. In a particular embodiment said material is as described above.

In a further embodiment said use involves a mixture of containing Napropamide as described above.

The invention will now be further described with reference to the following non-limiting example:

### EXAMPLE 1

A greenhouse study was carried out to compare the effectiveness of different herbicides to prevent root penetration in bitumen roof sealing membranes without killing the plant or adversely affecting it.

The herbicides were incorporated into bitumen 160/220 (thickness 4.5-6 mm) during a standard bitumen manufacturing process. The manufacturing process comprised a step of heating the bitumen mixture before a fibreglass grid was incorporated as a reinforcement of the bitumen membrane.

The herbicides Napropamide (N,N-Diethyl-2-(1-naphthyloxy)propanamide, CAS No. (S)-(+) isomer: 41643-36-1) and Prodiamine (2,4-dinitro-N3,N3-dipropyl-6-(trifluoromethyl)-1,3-benzenediamine, CAS No. 29091-21-2) were formulated as oil dispersion with 25% active ingredient. The (R)-2-(4-chlorine-o-tolyloxy)propionic acid ethyl-hexylester (trader name: ‘HERBITECT™’, 2 ethylhexyl-2-(R)-2-(4-chloro-o-tolylory)propionate) may be obtained from Büsscher & Hoffman, Fabrikstrasse 2, A-4470 Enns, Austria and was formulated as oil dispersion with approx. 95% active ingredient.

Resistance of the bitumen against root penetration was evaluated according to the standard test method known in the art as: DIN CEN/TS 14416 ‘Geosynthetische Dichtungsbahnen—Prüfverfahren zur Bestimmung des Widerstandes gegen Wurzeln, Deutsche Fassung CEN/TS14416:2005’. Bitumen membranes containing Napropamide and Prodiamine, respectively were evaluated at active ingredient concentrations of 0.5%, 0.25%, 0.125% and 0.0625% based on raw bitumen. The (R)-2-(4-chlorine-otolyloxy) propionic acid ethyl-hexylester (‘HERBITECT™’) was used as a commercial standard at an active ingredient concentration of 0.38% (product rate 0.4%) based on raw bitumen. Bitumen membranes without incorporated herbicide were used as a control. Three discs with a diameter of 25 cm were punched out of each bitumen membrane and used for the study.

Unglazed, earthenware flowerpots approx. 22 cm high were filled with a soil-mixture [soil low in calcium/TKS1 (3:1)] to 10 cm from the bottom of the pot. Bitumen discs were put on top of the soil layer and the gap between the disc and the pot was sealed with aquarium silicone sealant. The diameter of the discs was approximately that of the internal diameter halfway up the pots. The bitumen discs were covered with approximately 9 cm soil and a plastic watering pipe was insert into the soil of each pot. Thirty five lupine seeds (Lupinus albus) were planted in the soil and covered with about 1 cm of soil. Two pots filled only with soil were used as a control for seed germination and plant growth.

The seeds were growing in a greenhouse under artificial light (14 h photoperiod, 20-22° C., relative humidity 60%). The soil above the bitumen disc was watered with rain water led through the plastic pipe into the pots so that the surface of the bitumen was kept damp. The soil beneath the bitumen discs was kept moist by standing from time to time the pots in water-filled trays. After six weeks the soil of the pots was removed from the roots by gentle running water. The bottom side of bitumen membranes was inspected to see whether any roots have grown through the bitumen, and the upper side was examined to assess the number of roots penetrating the bitumen and the depth of penetration. During the assessments, bitumen discs, roots, and above ground parts of the plants were recorded.

The effectiveness of the herbicides as root barriers are shown in Table 1. The seeds germinated and grew normally without visible effects to roots and above ground parts in pots containing untreated bitumen and bitumen treated with herbicides, respectively. When the upper side of bitumen was assessed, bitumen membranes containing Napropamide at 0.5% and 0.25%, respectively and the standard product “HERBITECT™” at 0.38% were penetrated to less extent compared to the untreated bitumen. Napropamide at 0.5% and 0.25% stopped completely root elongation through bitumen with exception in a replicate showing one root penetration. Prodiamine was slightly less effective to restrict root growth throughout bitumen compared to Napropamide and the standard product “HERBITECT™” without any root penetration. In contrast, twenty six to more than 50 roots grew throughout the untreated bitumen membranes.

This study showed that Napropamide was highly effective to prevent root penetration of bitumen membranes and was not harmful to the remaining plant parts.

TABLE 1
Effect of Napropamide, Prodiamine and (R)-2-(4-chlorine-o-tolyloxy) propionic acid
ethyl-hexylester (‘HERBITECT ™’) to prevent root penetration in bitumen membranes.

| | | Plant | No. of | | | | | | |
|---|---|---|---|---|---|---|---|---|---|
| | Active Ingredient | height | emerged | No. of roots | No. of roots | No. of roots grew | | | |
| | concentration based | average | plants | stopped at | grew into | thoughout bitumen | | | |
| compound | on raw bitumen | (cm) | average | bitumen average | bitumen average | (3 replicates shown) | | | average |
| Napropamide | 0.5% | 32.3 | 32.7 | approx. >50 | 30.3 | 1 | 0 | 0 | 0.3 |
| Napropamide | 0.25% | 35.0 | 33.0 | approx. >50 | 40.0 | 0 | 0 | 1 | 0.3 |
| Napropamide | 0.125% | 34.0 | 32.0 | approx. >50 | approx. >50 | 0 | 2 | 0 | 0.7 |
| Napropamide | 0.0625% | 36.3 | 32.3 | approx. >50 | approx. >50 | 1 | 1 | 2 | 1.3 |
| Prodiamine | 0.5% | 34.0 | 34.3 | approx. >50 | approx. >50 | 1 | 3 | 4 | 2.7 |
| Prodiamine | 0.25% | 31.0 | 34.3 | approx. >50 | approx. >50 | 9 | 6 | 5 | 6.7 |
| Prodiamine | 0.125% | 32.3 | 34.7 | approx. >50 | approx. >50 | 12 | 18 | 6 | 12.0 |
| Prodiamine | 0.0625% | 33.7 | 33.7 | approx. >50 | approx. >50 | 27 | 16 | 18 | 20.3 |
| Herbitect^{$} | 0.38% | 34.0 | 33.0 | approx. >50 | 46.7 | 0 | 0 | 0 | 0 |
| control, | — | 28.0 | 34.3 | approx. >50 | approx. >50 | 26 | 49 | >50 | >42 |
| untreated | | | | | | | | | |
| bitumen | | | | | | | | | |
| control | — | 23.5* | 32.5* | — | — | — | — | — | — |
| without | | | | | | | | | |
| bitumen | | | | | | | | | |

^{$}product name (2 ethylhexyl-2-(R)-2-(4-chloro-o-tolylory)propionate)
*average of 2 replicates

The materials according to the invention which contain Napropamide as active ingredient demonstrate good overall inhibition of root penetration/damage.

1. A building material comprising Napropamide present in an amount sufficient to inhibit penetration of said material by a plant root.

2. The building material according to claim 1, wherein said material is selected from the group consisting of bitumen, roofing materials, sealants, insulation, plastics, geotextiles, tunnel liner and piping.

3. The material according to claim 1, wherein said material is bitumen.

4. The material according to claim 1 further comprising:
a herbicide, an insecticide, a fungicide, or a mixture thereof.

5. (canceled)

6. A method for protecting a building material from damage resulting from penetration of said material by a plant root the method comprising:
adding and/or treating said material with an amount of Napropamide which is sufficient to prevent penetration of said material by the plant root.

7. The method according to claim 6, wherein said Napropamide is added during manufacture of said building material.

8. The method according to claim 6, wherein said building material is treated with Napropamide after manufacture of said building material.

9. The method according to claim 6, wherein said building material is bitumen.

10. (canceled)
